(19) United States
(12) Patent Application Publication
(10) Pub. No.: US 2018/0293414 A1
(43) Pub. Date: Oct. 11, 2018

(54) SYSTEM AND METHOD DETERMINING SPATIAL RELATIONSHIPS OF PHYSICAL OBJECTS

(71) Applicants: Zheng Shi, Beijing (CN); Hanyin Ye, Beijing (CN)

(72) Inventors: Zheng Shi, Beijing (CN); Hanyin Ye, Beijing (CN)

(21) Appl. No.: 16/006,870

(22) Filed: Jun. 13, 2018

Related U.S. Application Data
(63) Continuation-in-part of application No. PCT/CN2016/098485, filed on Sep. 8, 2016.

(30) Foreign Application Priority Data
Dec. 16, 2015 (CN) 2015109448728

(51) Int. Cl. G06K 7/10; G06K 19/07; G06K 19/08; G10K 15/00

(52) U.S. Cl. CPC G06K 7/10356; G06K 7/10366; G10K 15/00; G06K 19/083; G06K 19/0728

(57) ABSTRACT

The present invention provides a system and accompanying method determining the spatial relationships of physical objects, including multiple physical objects, a reader antenna and a processor. Each physical object has a first surface, a second surface parallel to the first surface, one or more RFID tags, and one or more relay antennas. A first RFID tag is placed on the interior surface of the first surface, a second RFID tag is placed on the interior surface of the second surface, and a first relay antenna is located between the first surface and the second surface. The processor is configured to direct the reader antenna to detect the RFID tags. Once the first physical object is placed above the reader antenna, with the first surface of the first physical object facing the reader antenna, the reader antenna is configured to detect the first RFID tag of the first physical object. And once the second physical object is placed above the first physical object, with the first surface of the second physical object facing the second surface of the first physical object, the reader antenna is configured to further detect the second RFID tag of the first physical object and the first RFID tag of the second physical object.

### CROSS-REFERENCE TO RELATED APPLICATION

This application is a continuation in part of International Patent Application No. PCT/CN2016/098485, entitled “System and Method Determining Spatial Relationships of Physical Objects”, filed on Sep. 8, 2016, which claims priority of Patent Application CN2015109448728, entitled “System for Determining Spatial Relationships of Physical Objects”, filed on Dec. 16, 2015. The entire disclosure of the above application is incorporated herein by reference.

### TECHNICAL FIELD

The present invention relates to the field of electronic detection, and in particular, to a system determining spatial relationships of physical objects, which can be used in toys and teaching aids.

### BACKGROUND

The use of toy blocks in educational games greatly benefits the development of children. As a result, toy blocks have been extensively praised. Games using toy blocks may help children most in intelligence and creativity.

Although toy blocks have been widely accepted and used, little work has been done to improve the classic designs of them. Indeed, with the advent of the computer age, toy makers and educators have made use of the advancement of technologies. One example is that computer games provide a visual display for game activities through an electronic display system (such as pixel flat panel display or touch screen).

Unfortunately, such display is unable to provide physical interaction between players and toys. On the other hand, traditional toys often lack audio and/or visual interaction or other forms of sophisticated feedback that computerized games can offer. Therefore, a method that combines both computerized technology and physical play can effectively enhance a player's experience by allowing their physical actions to be interpreted by a computer system so as to provide real-time feedback to the player in the form of a multitude of sensorial accessories such as video and/or audio outputs.

### SUMMARY OF THE INVENTION

Aiming to solve the problems above, the present invention provides a system and the accompanying method for determining spatial relationships of multiple physical objects.

In accordance with one embodiment of the present invention, the system determining spatial relationships of physical objects includes multiple physical objects, a reader antenna and a processor. Each physical object has a first surface, a second surface, one or more RFID tags, and one or more relay antennas. The second surface is parallel to the first surface, and a first RFID tag is placed on the interior surface of the first surface, and a second RFID tag is placed on the interior surface of the second surface, and a first relay antenna is located between the first surface and the second surface. The processor is configured to direct the reader antenna to detect the RFID tags, and the relay antennas are configured to transmit energy and communication data. Once the first physical object is placed above the reader antenna and the first surface of the first physical object faces the reader antenna, the reader antenna is configured to only detect the first RFID tag of the first physical object. And once the second physical object is placed above the first physical object and the first surface of the second physical object faces the second surface of the first physical object, the reader antenna is configured to further detect the second RFID tag of the first physical object as well as the first RFID tag of the second physical object. “Further” here indicates that, when the second physical object is placed above the first physical object and the first surface of the second physical object faces the second surface of the first physical object, the reader antenna does not only detect the first RFID tag of the first physical object, but also the second RFID tag of the first physical object and the first RFID tag of the second physical object.

In accordance with one embodiment of the present invention, once the third physical object is placed above the second physical object and the first surface of the third physical object faces the second surface of the second physical object, the reader antenna is configured to further detect the second RFID tag of the second physical object as well as the first RFID tag of the third physical object. Therefore, the processor recognizes the second surface of the second physical object and the first surface of the third physical object. “Further” here indicates that, when the third physical object is placed above the second physical object and upon the first surface of the third physical object faces the second surface of the second physical object, the reader antenna does not only detect the first and the second RFID tags of the first physical object and the first RFID tag of the second physical object, but also the second RFID tag of the second physical object and the first RFID tag of the third physical object.

In accordance with one embodiment of the present invention, the physical object further has a third surface and a fourth surface, the fourth surface is parallel to the third surface, a third RFID tag is located inside the third surface, a fourth RFID tag is located inside the fourth surface, a second relay antenna is located between the third surface and the fourth surface, and the second relay antenna is perpendicular to the first relay antenna.

In accordance with one embodiment of the present invention, the physical object further has a fifth surface and a sixth surface, the sixth surface is parallel to the fifth surface, a fifth RFID tag is located inside the fifth surface, a sixth RFID tag is located inside the sixth surface, a third relay antenna is located between the fifth surface and the sixth surface, and the first relay antenna, the second relay antenna and the third relay antenna are perpendicular to each other.

In accordance with one embodiment of the present invention, the system further includes an array of electrodes placed above the reader antenna.

In accordance with one embodiment of the present invention, the processor is configured to direct the array of electrodes to detect the magnitude of the capacitive coupling between the physical objects and the array of electrodes, and to further recognize the location of the physical objects and the finger touch acted on the physical objects.

In accordance with one embodiment of the present invention, once multiple physical objects are placed together and above the reader antenna, the processor is configured to direct the reader antenna to detect the RFID tags of the physical objects, and to recognize the location of the physical objects, and to further derive the spatial relationship of the physical objects.

In accordance with one embodiment of the present invention, each physical object represents a timbre, and each surface of the physical object is visually marked to represent a music texture.

In accordance with one embodiment of the present invention, once multiple physical objects are placed together and above the reader antenna, the processor is configured to produce a melody based on the detected RFID tags.

In accordance with one embodiment of the present invention, the system further includes a display device that is directed by the processor to display the music score of the melody.

The present invention provides a system in which multiple physical objects placed together and their spatial distribution can be recognized. The system can be used for multiple purposes such as toys and teaching aids, as the physical objects can physically interact with users, the system can provide feedback to users to effectively enhance the user experience.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are only for exemplary embodiments of the present invention, and that a person of ordinary skill in the art may derive additional drawings without deviating from the principles of the present invention.

FIG. 1 is a schematic diagram illustrating the system determining the spatial relationships of physical objects in accordance with embodiment one of the present invention.

FIG. 2 is a schematic diagram illustrating the process flow of the system determining the spatial relationships of physical objects in accordance with embodiment one of the present invention.

FIG. 3 is a schematic diagram illustrating the system determining the spatial relationships of physical objects in accordance with embodiment two of the present invention.

FIG. 4 is a schematic diagram illustrating the relay antennas of the cubes in accordance with embodiment two of the present invention.

FIG. 5 is a schematic diagram illustrating the musical toy blocks in accordance with one embodiment of the present invention.

### DETAILED DESCRIPTION OF THE INVENTION

To better illustrate the purpose, technical feature, and advantages of the embodiments of the present invention, various embodiments of the present invention will be further described in conjunction with the accompanying drawings.

While the present invention will be described in connection with various specific embodiments, the invention is not limited to these embodiments. People skilled in the art will recognize that the system and method of the present invention may be used in many other applications. The present invention is intended to cover all alternatives, modifications and equivalents within the spirit and scope of invention, which is defined by the apprehended claims.

The technical scheme in the embodiment of the present invention will be described clearly and completely by reference to the accompanying drawings.

### Embodiment One

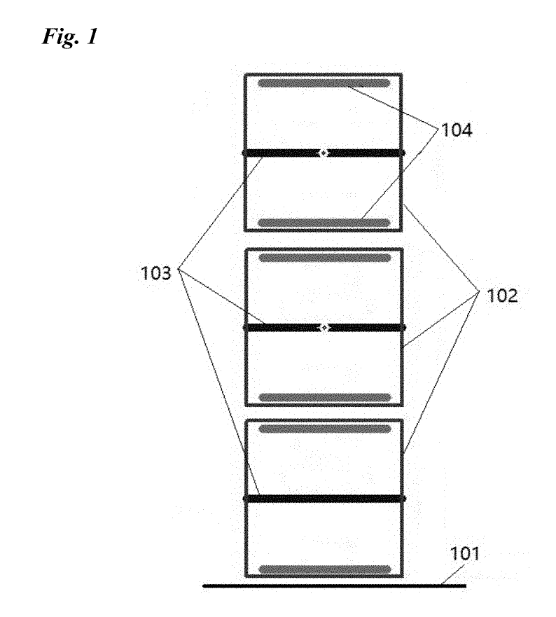

FIG. 1 is a schematic diagram illustrating the system described in embodiment one. Embodiment one provides a system determining the spatial relationships of physical objects, including multiple physical objects 102 of the same size, a reader antenna 101, and a processor. Each physical object has a first surface, a second surface, one or more RFID tags 104, and one or more relay antennas 103. The second surface is parallel to the first surface, a first RFID tag 104 is placed on the interior surface of the first surface, a second RFID tag 104 is placed on the interior surface of the second surface, and a first relay antenna 103 is located between the first surface and the second surface. The processor is configured to direct the reader antenna 101 to detect the RFID tags 104.

The height of a physical object 102 refers to the distance between the first surface and the second surface of it. The detection distance of the reader antenna 101 is shorter than the height of the physical object 102. When the first physical object 102 is placed above the reader antenna 101, the detection distance of reader antenna 101 is still shorter than the height of the physical object 102. When the first physical object 102 is placed above the reader antenna 101 and a second physical object 102 is placed above the first physical object 102, the detection distance of the reader antenna 101 is longer than the height of the physical object 102 but shorter than twice of the height of the physical object 102. And when the first physical object 102 is placed above the reader antenna 10 land the second physical object 102 is placed above the first physical object 102 and a third physical object 102 is placed above the second physical object 102, the detection distance of the reader antenna 101 is longer than twice of the height of the physical object 102 but shorter than thrice of the height of the physical object 102.

Further, the physical object 102 has a third surface and a fourth surface. The fourth surface is parallel to the third surface, a third RFID tag 104 is located inside the third surface, a fourth RFID tag 104 is located inside the fourth surface, a second relay antenna 103 is located between the third surface and the fourth surface, and the second relay antenna 103 is perpendicular to the first relay antenna 103.

Further, the physical object 102 further comprises a fifth surface and a sixth surface, the sixth surface is parallel to the fifth surface, a fifth RFID tag 104 is located inside the fifth surface, a sixth RFID tag 104 is located inside the sixth surface, a third relay antenna 103 is located between the fifth surface and the sixth surface, and the first relay antenna 103, the second relay antenna 103 and the third relay antenna 103 are perpendicular to each other.

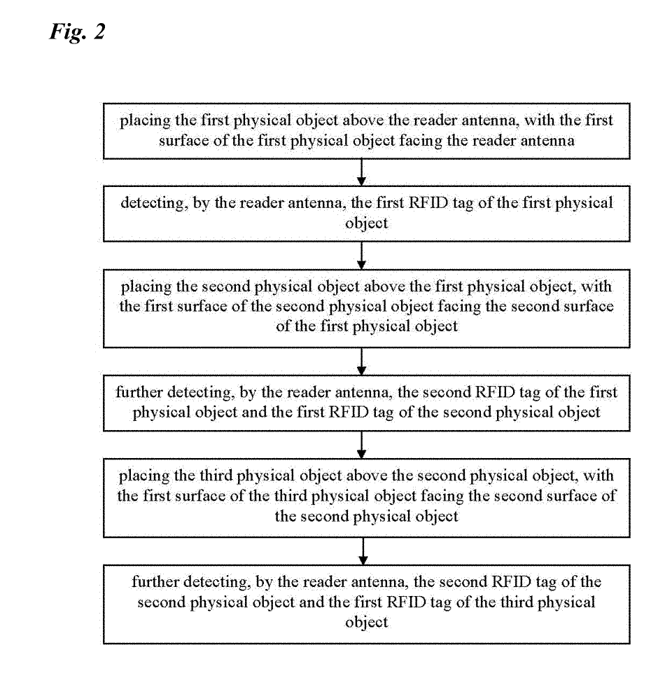

The process flow of the system determining spatial relationships of physical objects in embodiment one is shown in FIG. 2, as follows:

Step one: placing the first physical object above the reader antenna, with the first surface of the first physical object facing the reader antenna;

Step two: detecting, by the reader antenna, the first RFID tag of the first physical object, for the processor to recognize the first surface of the first physical object;

Step three: placing the second physical object above the first physical object, with the first surface of the second physical object facing the second surface of the first physical object;

Step four: further detecting, by the reader antenna, the second RFID tag of the first physical object and the first RFID tag of the second physical object, for the processor to recognize the second surface of the first physical object and the first surface of the second physical object;

Step five: placing the third physical object above the second physical object, with the first surface of the third physical object facing the second surface of the second physical object;

Step six: further detecting, by the reader antenna, the second RFID tag of the second physical object and the first RFID tag of the third physical object, for the processor to recognize the second surface of the second physical object and the first surface of the third physical object.

### Embodiment Two

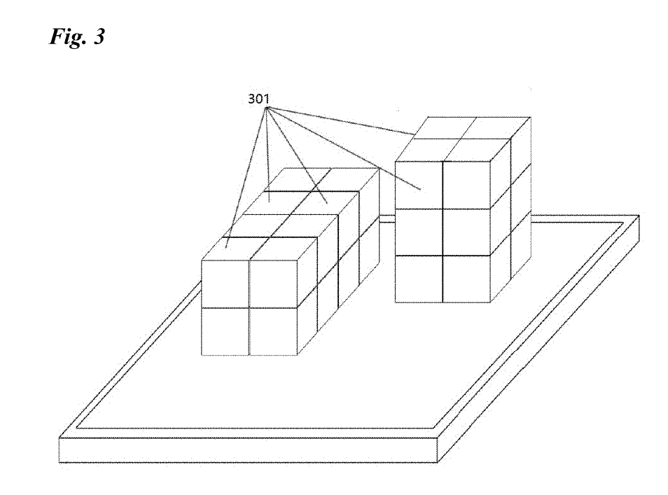

FIG. 3 is a schematic diagram illustrating the system determining the spatial relationships of physical objects, including an array of electrodes. The system further includes an array of electrodes that is placed above the reader antenna. Both the array of electrodes and the reader antenna are embedded in the interactive board. In this embodiment, electrodes are made of metal materials, such as aluminum, copper, etc. The materials making up the cubic physical objects 301 can capacitively couple with the electrodes. The processor is configured to direct the array of electrodes to detect the magnitude of the capacitive coupling between the physical objects and the array of electrodes, and to further recognize the location of the physical objects and the finger touch acted on the physical objects. The reader antenna has totally four loops, with single-sided wiring. The outer loop is 77×77 mm, and the inner loop is 69×69 mm.

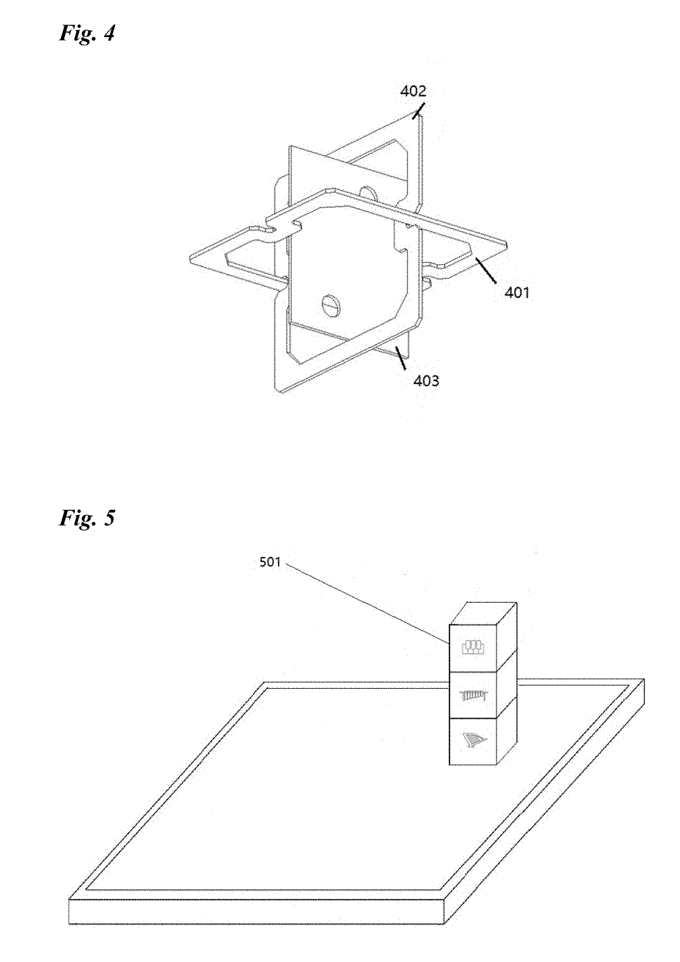

The size of each cubic physical object 301 is 40×40×40 mm. An RFID tag is placed on each of the six surface of the cube. The RFID tag has a size of 14.5×14.5 mm, placed at the center of each surface, embedded 2 mm off the surface. The relay antenna embedded in the cubic physical object 301 is shown in FIG. 4. The relay antenna 401 in X direction is of the same size as the relay antenna 402 in Y direction, with the inner loop of 29.7×29.7 mm and the outer loop of 32.7×32.7 mm. The relay antenna in both X and Y directions has 3 loops, with single-sided wiring and the matching capacitance of 150 pF+5 pF. The relay antenna 403 in Z direction has totally four loops, with an inner loop of 19.5×25.9 mm and an outer loop of 20.3×27.4 mm, double-sided wiring, and the matching capacitance of 100 pF+33 pF.

When multiple physical objects 301 are placed together and above the array of electrodes, the processor is configured to direct the reader antenna to detect the RFID tags of the physical objects 301, and to recognize the location of the physical objects 301, and to further derive the spatial relationship of the physical objects 301.

### Embodiment Three

FIG. 5 is a schematic diagram illustrating musical toy blocks in the present invention. Each physical object 501 represents a timbre, and each surface of the physical object 501 is visually marked to represent a music texture. Different textures are represented by different icons. For example, note is used to represent pitch and rhythm for piano, whereas score is used for percussions, playing styles and fretboard maps are used for guitar.

After three physical objects 501 have been stacked above the reader antenna, they are activated by a finger touch of a user. The processor is configured to direct the array of electrodes to detect the magnitude of the capacitive coupling between the physical objects and the array of electrodes, and to further recognize the finger touch acted on the physical objects. The processor then produces a melody based on the detection of the first RFID tags of the first, the second and the third physical objects 501. When the timbres and the textures of the three RFID tags are the same, the three notes are combined to form harmony. If the timbres are the same but the textures are different, the textures represented by each surface are played simultaneously to form a melody. If both the timbres and the textures are different, a variety of musical melodies are formed for multiple instruments in different tracks.

The system determining spatial relationships of physical objects provided in embodiment three further includes a display device. The processor is configured to direct the display device to play the music score of the melody.

1. A system determining spatial relationships of physical objects, comprising:
a plurality of physical objects, each comprising a first surface, a second surface, one or more RFID tags, and one or more relay antennas, wherein the second surface is parallel to the first surface, a first RFID tag is placed on the interior surface of the first surface, a second RFID tag is placed on the interior surface of the second surface, and a first relay antenna is located between the first surface and the second surface;
a reader antenna;
a processor configured to direct the reader antenna to detect the RFID tags;
wherein, upon the first physical object being placed above the reader antenna, and upon the first surface of the first physical object facing the reader antenna, the reader antenna is configured to detect the first RFID tag of the first physical object;
and wherein, upon the second physical object being placed above the first physical object, and upon the first surface of the second physical object facing the second surface of the first physical object, the reader antenna is configured to further detect the second RFID tag of the first physical object and the first RFID tag of the second physical object.

2. The system of claim 1, wherein, upon the third physical object being placed above the second physical object, and upon the first surface of the third physical object facing the second surface of the second physical object, the reader antenna is configured to further detect the second RFID tag of the second physical object and the first RFID tag of the third physical object.

3. The system of claim 2, wherein the physical object further comprises a third surface and a fourth surface, the fourth surface is parallel to the third surface, a third RFID tag is located inside the third surface, a fourth RFID tag is located inside the fourth surface, a second relay antenna is located between the third surface and the fourth surface, and the second relay antenna is perpendicular to the first relay antenna.

4. The system of claim 3, wherein the physical object further comprises a fifth surface and a sixth surface, the sixth surface is parallel to the fifth surface, a fifth RFID tag is located inside the fifth surface, a sixth RFID tag is located inside the sixth surface, a third relay antenna is located between the fifth surface and the sixth surface, and the first relay antenna, the second relay antenna and the third relay antenna are perpendicular to each other.

5. The system of claim 4, further comprising an array of electrodes placed above the reader antenna.

6. The system of claim 5, wherein, the processor is configured to direct the array of electrodes to detect the magnitude of the capacitive coupling between the physical objects and the array of electrodes, and to further recognize the location of the physical objects and the finger touch acted on the physical objects.

7. The system of claim 6, wherein, upon a plurality of physical objects being placed together and above the array of electrodes, the processor is configured to direct the reader antenna to detect the RFID tags of the physical objects, and to recognize the location of the physical objects, and to further derive the spatial relationship of the physical objects.

8. The system of claim 7, wherein each physical object represents a timbre, and each surface of the physical object is visually marked to represent a music texture.

9. The system of claim 8, wherein, upon a plurality physical objects being placed together and above the reader antenna, the processor is configured to produce a melody based on the detected RFID tags.

10. The system of claim 9, further comprising a display device, wherein the processor is configured to direct the display device to display the music score of the melody.

11. A method for determining spatial relationships of physical objects, comprising:
placing a first physical object above a reader antenna, wherein the first physical object comprises a first surface, a second surface, one or more RFID tags, and one or more relay antennas, and wherein the second surface is parallel to the first surface, a first RFID tag is placed on the interior surface of the first surface, a second RFID tag is placed on the interior surface of the second surface, and a first relay antenna is located between the first surface and the second surface;
upon the first surface of the first physical object facing the reader antenna, directing, by a processor, the reader antenna to detect the first RFID tag of the first physical object;
placing a second physical object above the first physical object;
upon the first surface of the second physical object facing the second surface of the first physical object, directing, by the processor, the reader antenna to further detect the second RFID tag of the first physical object and the first RFID tag of the second physical object.

12. The method of claim 11, further comprising, upon the third physical object being placed above the second physical object, and upon the first surface of the third physical object facing the second surface of the second physical object, further detecting the second RFID tag of the second physical object and the first RFID tag of the third physical object, by the reader antenna.

13. The method of claim 12, wherein the physical object further comprises a third surface and a fourth surface, the fourth surface is parallel to the third surface, a third RFID tag is located inside the third surface, a fourth RFID tag is located inside the fourth surface, a second relay antenna is located between the third surface and the fourth surface, and the second relay antenna is perpendicular to the first relay antenna.

14. The method of claim 13, wherein the physical object further comprises a fifth surface and a sixth surface, the sixth surface is parallel to the fifth surface, a fifth RFID tag is located inside the fifth surface, a sixth RFID tag is located inside the sixth surface, a third relay antenna is located between the fifth surface and the sixth surface, and the first relay antenna, the second relay antenna and the third relay antenna are perpendicular to each other.

15. The method of claim 14, wherein an array of electrodes is placed above the reader antenna.

16. The method of claim 15, further comprising, directing the array of electrodes to detect the magnitude of the capacitive coupling between the physical objects and the array of electrodes, and further recognizing the location of the physical objects and the finger touch acted on the physical objects, by the processor.

17. The method of claim 16, further comprising, upon a plurality of physical objects being placed together and above the array of electrodes, directing the reader antenna to detect the RFID tags of the physical objects, and recognizing the location of the physical objects, and further deriving the spatial relationship of the physical objects, by the processor.

18. The method of claim 17, wherein each physical object represents a timbre, and each surface of the physical object is visually marked to represent a music texture.

19. The method of claim 18, further comprising, upon a plurality physical objects being placed together and above the reader antenna, producing a melody based on the detected RFID tags by the processor.

20. The method of claim 19, further comprising directing a display device to display the music score of the melody by the processor.
